(19) United States
(12) Patent Application Publication
(10) Pub. No.: US 2025/0025262 A1
(43) Pub. Date: Jan. 23, 2025

(54) DENTAL HANDPIECE WITH TEMPERATURE SENSOR

(71) Applicant: KING SAUD UNIVERSITY, RIYADH (SA)

(72) Inventors: OMAR MOHAMMED ALSHEHRI, RIYADH (SA); MOHAMMED ABDUALLAH ALSHEHRI, RIYADH (SA)

(21) Appl. No.: 18/888,058

(22) Filed: Sep. 17, 2024

Related U.S. Application Data
(63) Continuation-in-part of application No. 18/134,965, filed on Apr. 14, 2023.

(51) Int. Cl. A61C 1/12; A61C 1/00; A61C 1/08; A61C 19/04; G01J 5/00

(52) U.S. Cl. CPC A61C 1/12; A61C 1/0015; A61C 1/088; A61C 19/04; G01J 5/0025

(57) ABSTRACT

A medical or dental handpiece is provided with a temperature measurement device for measuring the temperature of the handpiece or a part of the handpiece described. The temperature measurement device can be designed to measure the temperature of the handpiece or a part of the handpiece in a contact less manner by detecting electromagnetic radiation, in particular heat radiation from heat sources associated with the handpiece. Alternatively, the temperature measurement device may be configured to measure the temperature of the interior of the handpiece that can be heated by at least one heat source. Alternatively, the temperature measurement device can be an electrical temperature measurement device.

### RELATED APPLICATION

The present patent application is a Continuation in Part to U.S. patent application Ser. No. 18/134,965 filed Apr. 14, 2023, and claims priority to that application and is filed by the inventors hereof and which is incorporated by reference herein.

### BACKGROUND

### Technical Field

This invention relates to a high speed handpiece for dental examinations and procedures and more particularly to a high speed handpiece with an integrated temperatures measurement sensor.

### Background Art

The present invention relates to a medical, a dental, handpiece with a temperature measurement device (i.e., a temperature sensor) for measuring the temperature of the entire handpiece housing or a specific part of the handpiece during dental examinations and procedures.

Such a handpiece is for example from the U.S. Pat. No. 6,787,892 B2 to Mc Ie, et al., hereinafter referred to as “Mc Ie”) known in the art. The disclosed handpiece is provided with a detachable cap or paint or varnish containing a temperature sensitive or thermal chromic dye which indicates a temperature change by a color change of the dye. The disadvantage of this instrument is, inter alia, that the thermal chromic dye indicates an imprecise and delayed status of the temperature change and as such the temperature measurement is commensurate only with the portions upon which the thermal chromic dye attached.

Another teaching, US 2009/03322541 A1 to Jones, et al., (hereinafter referred to as “Jones”) shows a handpiece where the head housing is provided with a skeletal or rib-like belt with a central band and protruding side detection bands on which are provided, inter alia, temperature sensors. The lateral detection bands transmit the heat emitted by the different heat sources by means of heat conduction to the temperature sensors to the temperature sensors. The disadvantage of this handpiece, inter alia, is in the temperature measurement which is delayed due to the heat conduction process via the detection bands and the imprecise temperature measurements and the limitations of the temperature measurements due to the spatial arrangement of the detection bands to specific regions or components of the handpiece.

### SUMMARY

The tool of the present invention is a handpiece for medical, in particular dental, examinations and procedures which uses adaptive temperature warning sensors to aid the practitioner in bone and tooth structure removal. The adaptive temperature warning sensors measure the temperatures of the bones and tooth structures from their heat emitted during the removal process caused from friction of the device upon the compromised bone mass or tooth structure thereby aiding in helping avoid bone and pulp necrosis.

The present invention is therefore based on the object to provide in a medical, in particular dental, handpiece with an alternative temperature measuring device (i.e., temperature sensor) for measuring the temperature of the handpiece or part of the handpiece, which in particular does not have one of the disadvantages mentioned above.

According to one exemplary embodiment, a medical, in particular dental, handpiece is provided for this purpose, comprising: an outer sleeve, a drive device for moving a tool which can be connected to the handpiece and a temperature measuring device (i.e., temperature sensor) for measuring the temperature of the handpiece or a part of the handpiece, where in particular, the temperature measuring device is designed to measure the temperature of the handpiece, for example, one or more components of the handpiece or an interior and/or interior portion of the handpiece in a contact-less manner by detecting electromagnetic radiation, in particular heat radiation.

The advantage of a temperature measuring device which measures the temperature in a contact-less manner by detecting electromagnetic radiation is, inter alia, that the temperature measurement takes place very quickly and independently due to being spatially separated from the heat source. As a result of the spatial separation, preferable a temperature measurement of a movable or moving component or components of the handpiece is possible without contacting the latter, as a result of which, in, wear and tear on of the temperature measurement device is avoided. By detection of the electromagnetic radiation, the measurement of the temperature is also independent of external influences such as convection.

According to another exemplary embodiment, the temperature measuring device is arranged and/or configured to receive electromagnetic radiation of a plurality of heat sources arranged in or on the outer sleeve of the handpiece and/or of the outer sleeve, in particular to determine an average temperature value of the plurality of heat sources and/or of the outer sleeve. Preferably, the temperature measuring device, which measures the temperature in a contact-less manner by detection of the electromagnetic radiation is arranged and/or designed to be arranged such that it determines an averaged temperature value or average temperature value, in particular an average temperature value or average temperature value of several specified components of the handpiece and/or heat sources of the handpiece and/or one of a volume measuring device measuring the surrounding volume, for example, a partial volume of the handpiece, in particular the handpiece head of the device. The above-mentioned volume or partial volume whose average temperatures are measurable, in particular are greater than the volume of the temperature measuring device or the temperature sensor of the temperature measuring device, preferably several times greater than the volume of the temperature measuring device or the sensor of the temperature measuring device.

A temperature measuring device which receives electromagnetic radiation of a plurality of heat sources or which determines an averaged temperature value or average temperature value, for example, is arranged between the plurality of heat sources and/or components and/or has a plurality of side surfaces receiving electromagnetic radiation. In particular, the side surfaces are well suited to receiving electromagnetic radiation or head radiation from different directions.

According to another exemplary embodiment, a plurality of heat sources is present on or in the handpiece wherein in a particular heat source, the handpiece or parts of the handpiece are heated more than another proximal heat source or wherein in particular a heat source emits more heat or heat radiation than another heat source. For example, two bearings, in particular, roller or ball bearings, are provided in the handpiece and/or handpiece head, wherein said first handpiece bearing becomes warmer than said second handpiece bearing due to an infirmity or due to contamination. Preferably, the temperature measuring device which measures the temperature in a contact-less fashion by detection of the electromagnetic radiation is arranged and/or configured to measure an average temperature value of the handpiece or an average temperature value of an interior of the handpiece resulting from heat emissions of the plurality of heat sources or composed of the heat emissions from the plurality of heat sources. Advantageously, the temperature measurement device does not measure exclusively or not predominantly the temperature of a specific component.

Preferably, the temperature measuring device which measures the temperature on a contact-less fashion by detection of the electromagnetic radiation, arranged and/or formed to measure a temperature value, in particular a temperature value of the handpiece of a part of the handpiece or an interior of the handpiece, preferably an averaged temperature value of average temperature value which is influenced by one or more components of the handpiece, which are not formed as (primary of immediate) heat sources, but are heated by a heat source provided in the handpiece, for example, immovable components, which are connected to a heat source and are heated by this heat source by conduction or convection. Particularly preferably, the temperature measurement device which measures the temperature in a contact-less manner by detection of the electromagnetic radiation, is arranged and/or configured such that it measures a temperature value, preferably an averaged temperature value or an average temperature value which is influenced by at least one heat source and at least one component of the handpiece which is not formed directly as a heat source, but can be heated by a heat source provided in the handpiece.

Of course, the above-mentioned heat sources may include other components of the handpiece than said bearings. Any relatively moving components of the handpiece, preferably movable, or stationary, contacting components, such as a tool holder and a tool release device of the handpiece or parts of the tool holder and the tool release device or a rotor or a motor or generator or the outer sleeve of the handpiece and a relative thereto movable member of the handpiece. A heat source can also be formed by a component that can be supplied with electrical energy, such as a lighting device, an electric motor its coils, an electrical or electronic circuit, a sensor, or detector, etc. This list of possible heat sources is exemplary and not exhaustive and applies in a corresponding manner to all further described embodiments.

Preferably, the temperature measurement device, which is adapted to measure the temperature of the handpiece or a part of the handpiece in a contact-less manner by detection of electromagnetic radiation in the handpiece or inside the outer sleeve of the handpiece is arranged, whereby a particularly fast, immediate, and accurate measurement is ensured.

According to another exemplary embodiment, the at least one heat source arranged in the outer sleeve of the handpiece has an electromagnetic radiation emitting surface which is spatially spaced apart from a surface of the temperature measurement device receiving the electromagnetic radiation of the heat source. This spatial separation advantageously makes it possible to measure the temperatures of the plurality of heat sources and/or components connected to and heated by a heat source and/or an average temperature value of the handpiece of an average temperature value of an interior of the handpiece resulting from the heat emissions of the heat sources and/or components.

According to further embodiments, the temperature measurement device which is designed to measure the temperature of the handpiece or a part of the handpiece in a contact-less manner by detecting electromagnetic radiation, includes a pyrometer or infrared sensor which detect electromagnetic radiation in the range of 5-20 microns. Alternatively, the temperature measurement device has an optical conductor for electromagnetic radiation such as a fiber rod whose scattering or refractive index values can vary due to temperature changes.

Preferably, a radiation conductor can be provided on the pyrometer or infrared sensor, which is designed to conduct heat radiation, in particular, infrared radiation to the pyrometer or infrared sensor. This is particularly advantageous if the pyrometer or infrared sensor cannot be positioned at the location where the temperature measurement is desired.

According to an alternative embodiment, a medical, in particular a dental handpiece is provided, comprising: a hollow outer sleeve with an interior, a drive device for moving a connection port with a handpiece tool, at least one arranged in the outer sleeve of the handpiece heat source, which by dispensing is heated by heat into the interior space of the interior, and a temperature measurement device which is adapted to measure the temperature heated space by the at least one heat source interior of the handpiece.

An advantage of this handpiece is that the temperature measurement device does not exclusively or not predominantly measure the temperature of a specific component, but that, preferably, in the presence of a plurality of heat sources, an averaged temperature value or an average temperature value can be determined by means of the temperature measurement device. Thus, advantageously, a plurality of heat sources can be monitored by a smaller number of temperature measurement devices, preferably several heat sources would be monitored by a single temperature measurement device. The plurality of heat sources would release at least a portion of their heat into the interior of the handpiece, preferably a partial volume of the handpiece, in particular the handpiece head in which a tool holder is provided for a tool connectable with the handpiece. The above-mentioned partial volume or the interior whose averaged temperature or average temperature is measurable, in particular, is greater than the volume of the temperature measurement device or the sensor of the temperature measurement device, preferably, several times greater than the volume of the temperature measurement device or the sensor of the temperature measurement device.

The interior of the handpiece is preferably formed by a fluid such as air containing a volume that separates components of the handpiece from each other, wherein in the volume, the temperature measurement device is provided. In this volume, the at least one heat source releases its heat. Alternatively, or additionally, the temperature measurement device is spatially spaced from the at least one heat source. Both measurements increase the independence of the temperature measurement from the at least one heat source or facilitate the determination of an averaged temperature value or an average temperature value.

The temperature measurement device configured to measure the temperature of the interior of the handpiece that can be heated by the at least one heat source comprises, for example, a pyrometer or an infrared sensor, which is designed in particular for electromagnetic radiation in a range of approximately 5 microns to approximately 20 microns or an optical conductor for electromagnetic radiation, in particular a fiber rod whose scattering or refractive index varies due to temperature changes, or an electrical temperature measurement device, for example a thermocouple or a temperature measurement device comprising a material whose electrical resistance or dynamic resistance depends on a variable temperature.

According to a further alternative embodiment, a medical, in particular, a dental handpiece is provided, comprising: an outer sleeve, a driving device for moving a handpiece connectable tool and a temperature measurement device for measuring the temperature of the handpiece or a part of the handpiece, wherein the temperature measurement device is designed as an electrical measurement device.

One advantage of an electrical temperature measurement device is, inter alia, the precise and rapid determination of the desired temperature value.

According to another embodiment, the electrical temperature measurement device has at least one thermocouple, which is designed to provide an electrical thermoelectric voltage signal for measuring the temperature. The advantage of the thermocouple lies in particular in its simple construction and its robustness, in particular against external influences which occur, for example, during the cleaning or sterilization of the handpiece. Preferably, a control and evaluation unit associated with the thermocouple is provided which determines a temperature value from the electrical thermoelectric voltage of the thermocouple.

The term thermocouple includes a device that converts heat into electrical energy by thermoelectricity. In particular, a thermocouple has two different and interconnected at one end, electrically conductive materials, in particular metals or metal wires in order to carry out temperature measurements. A thermocouple difference at the ends of the metals or metal wires creates electric charge separation for electrical thermoelectric voltage due to the Seebeck effect with two metals. This electrical potential difference is approximately proportional to the temperature difference at the ends of the metals. In order to be able to determine the absolute temperature at the metals or wire ends, further measurements must be taken, for example the measurement of the ambient temperature to which the temperature difference at the ends of the metals is added. Since the structure and function of a thermocouple are conventionally known to one of ordinary skill in the art, it will not be discussed further.

The at least one thermocouple preferably comprises two electrically conductive materials in particular, a metal or metal wire, for example steel, copper, a copper-nickel alloy (Konstantan) or other alloys, for example, nickel, chromium, iron, or copper.

Preferably, the at least one thermocouple is arranged in an interior of the handpiece, wherein the interior is formed by a fluid, in particular air, containing volume which separates components of the handpiece from each other. The at least one thermocouple advantageously measures in particular the temperature of the internal space and/or the (averaged) temperature of a plurality of heat sources which release heat into the interior and/or an averaged temperature or average temperature, in particular an average temperature of a component or an averaged temperature value of several components and/or heat sources of the handpiece and/or a volume space surrounding the temperature measurement device, for example, a partial volume of the handpiece.

Alternatively, the at least one thermocouple is provided on a component of the handpiece, in particular on a heat source or on a heat-emitting component, wherein preferably the component of the handpiece on which the thermocouple is provided has a material which is part of the thermocouple or the thermocouple compound. By providing the thermocouple on a component of the handpiece, in particular, the temperature of this component can be determined in an advantageous manner. By using a material of the component on which the thermocouple is arranged as a part of the thermocouple or the thermocouple compound the size of the thermocouple can be advantageously reduced and in particular when it is a larger component, for example, the outer sleeve of the handpiece, the contacting of the thermocouple which derives the thermoelectric signal away from the actual thermocouple connection (i.e., the contact point or region of the two materials of the thermocouple), whereby the arrangement of the thermocouple or the contacts and lines of for the derivation of the thermoelectric voltage signal in the cramped interior of the handpiece is simplified. Preferably, the component of the handpiece on which the thermocouple is provided and having a material which is part of the thermocouple or the thermocouple compound by an outer sleeve of the handpiece or by a width of the outer sleeve of the handpiece (electrically conductive) connected to the component of the handpiece. For example, a bearing or supporting a tool holder for the connectable tool handpiece tool or contact ring formed.

According to a further embodiment, the electrical temperature measurement device comprises a material who electrical resistance or dynamic resistance is variable as a function of the temperature. The material comprises, for example an ohmic resistor, an electrical conductor, in particular a metal, a ceramic, (a sintered metal oxide), or a doped semiconductor. At least one of these materials is preferably part of a sensor of the electrical temperature measurement device. Depending on the design, such a sensor is designed as an active sensor which requires a current or voltage supply for determining the temperature, or as an active sensor, which does not require a current or voltage supply for determining the temperature.

The term handpiece in particular comprises tangible medical or dental devices for example straight, pistol shaped, angled, or curved handpieces which are often referred to in the dental field as elbows, parts of handpieces or curved handpieces, or handles. In particular, a head portion, for example with one of the detachable handle sections can be connected, and couplings, adapters, connectors, and drive units, for example electric or pneumatic motors. The term handpiece further includes both corded and cordless handpieces, in particular with a replaceable or rechargeable energy source, and handpiece, which comprise the supply line and controller, regulating and/or supply unit connected thereto. According to a preferred embodiment, which is applicable to all mentioned embodiments and examples already mentioned above, the handpiece has a handpiece head, in which a tool holder for the tool connectable to the handpiece and the temperature measurement device, in particular the temperature sensor of the temperature measurement device are provided.

The present invention is therefore based on the object to provide a medical, in particular, a dental handpiece with an alternative temperature measurement device for measuring the temperature of the handpiece or a part of the handpiece which in particular does not have one of more of the disadvantages mentioned above.

According to a particular configuration, a dental handpiece for removing bones and tooth structures during oral surgical procedures includes a head part of said handpiece. The handpiece has an opening for inserting said connectable handpiece tool, a hollow head sleeve, a tool holder, and an actuator for actuating a tool release device for releasing the connectable handpiece tool. At least one temperature measurement device is provided to measure a temperature of oral cavity tissue in a contact-less manner by measuring the electromagnetic radiation emitted from a heat source associated with the dental handpiece. A control and evaluation unit receives temperature measurement signals from the temperature measurement device measuring oral cavity tissue and from the temperature measurement device measuring temperature of the heat source associated with the dental handpiece. The control and evaluation unit evaluates the temperature measurement signals and provides a temperature dependent control signal to interrupt or otherwise control the operation of said handpiece upon reaching or exceeding a predetermined temperature limit value. A power source for supplying electrical power to said handpiece is controlled by supplying control signals to the handpiece, and a supply/regulation unit for regulating an operation of said handpiece.

### BRIEF DESCRIPTION OF THE DRAWINGS

FIG. 1: An external view of an embodiment of a handpiece according to the invention with a temperature measurement device for measuring the temperature of the handpiece of a part of the handpiece.

FIG. 2: A cross-sectional view of an embodiment of a handpiece head with a temperature measurement device for measuring the temperature of the handpiece, wherein the temperature measurement device comprises a pyrometer or an infrared sensor.

### DETAILED DESCRIPTION

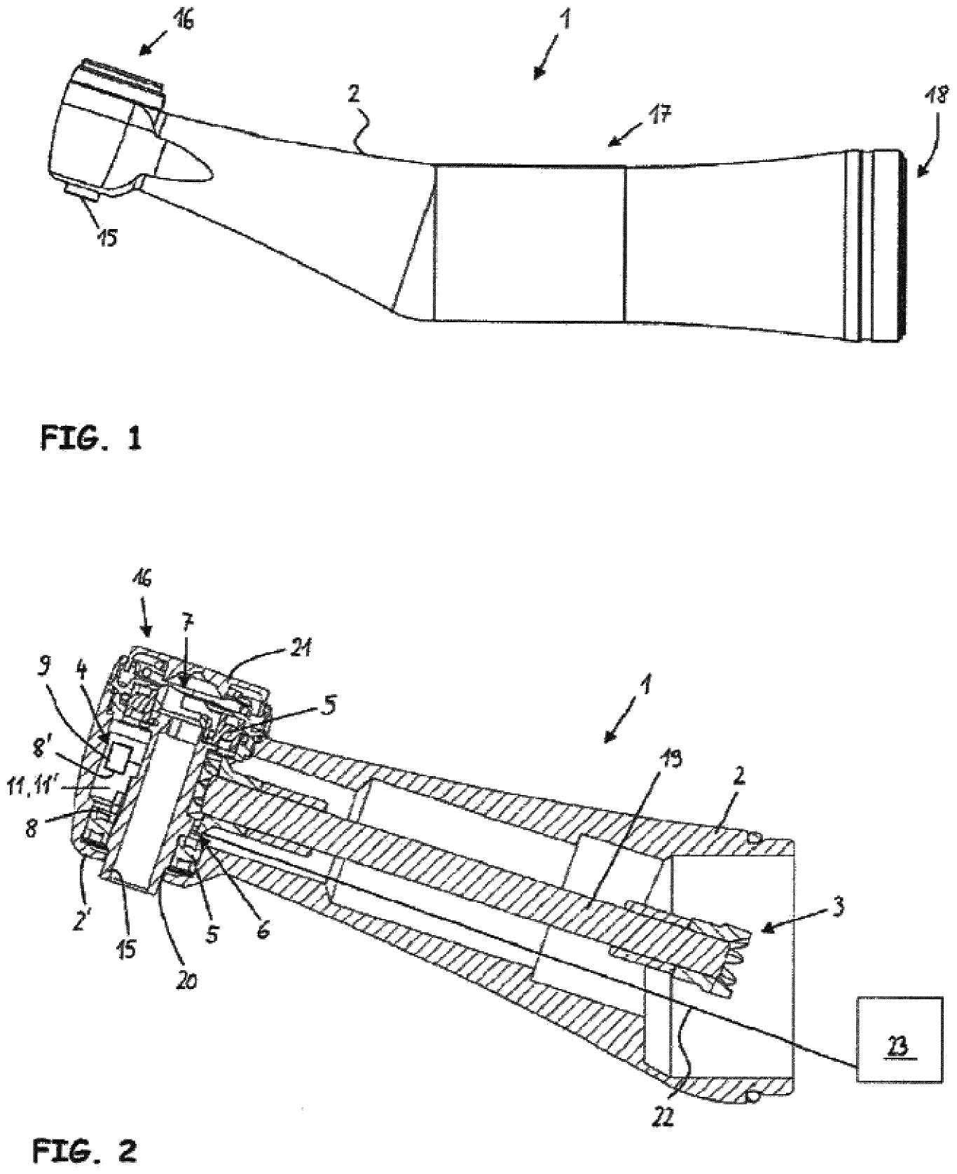

FIG. 1 shows an exterior view of a curved handpiece 1 which is often referred to as an angle piece with its outer sleeve 2. The handpiece 1 has a curved handle portion 17 and a head portion 16 in which a tool holder 15 for releasably connecting or receiving a connectable tool with the handpiece is preferably arranged. The tool holder 15 is preferably arranged to be moveable within the handpiece 1, for example rotatable, the rotatability being ensured by bearings 5 of the roller of ball type (see FIG. 2).

At the end of the handpiece 1 opposite the head part 16 there is provided a coupling or connecting device 18 which is designed to connect the handpiece 1 to one or more fluid sources, for example, a liquid source, in particular water, or a gas source, in particular compressed air. Preferably, the handpiece 1 via the connecting device 18 with an electrical power source and/or drive device, for example an electric motor or pneumatically operated motor, is connectable. Optionally, further electrical lines or contacts for data and/or signal transmission to the coupling device 18 are provided.

By the handpiece 1 and the outer sleeve 2, one or more fluid lines extend from the connecting device 18 in the direction of the head part 16 or into the head part 16. If necessary, the handpiece 1 also has one or more shafts 1, preferably by means of gears or gears 6 which serve as a drive device 3 and a drive movement means that is transmitted to the tool holder 15 (See FIG. 2).

FIG. 2 shows a section through a part of the handle part 17 and through the head part 16 of the handpiece 1. The head part 16 has a hollow head sleeve 2′ which forms an interior 11. The interior 11 is formed as a fluid, in particular air which contains the interior volume 11′ in which different components of the head part 16 are accommodated for example with respect to the sleeves 2, 2′ stationary components or in relation to the sleeves 2, 2′ moveable components, in particular, the bearings 5, tool holder 15, at least parts of a transmission 6 or gears, which transmit the drive movement of the drive device 3 of the shaft 19 to the tool holder 15, at least parts of a device 7 for releasing the tool from the tool holder 15, or more components such as spring elements, support elements, etc. On one side of the head portion 16, opening 20 is further provided through which the tool is inserted into the head part 16 or in the tool holder 15 and can be removed therefrom. On the side of the head part 16 which lies opposite to the opening 20, an actuating element 21 for actuating the tool release device 7 is provided, a pressure element or pressure cover.

At least some of the above-mentioned components or parts may be formed as heat sources, for example the bearings 5, the gear 6, or the tool release device 7. Of course, however, other components of the handpiece heat sources, in particular an electromagnetic radiation emitting component, for example a lighting device, a heating element for media, an electrical or electronic component, etc. Common to all these heat sources is that they deliver heat to the interior 11 of the handpiece 1 and/or the sleeves 2, 2′ of the handpiece. To determine the temperature of the handpiece 1 or a part of the handpiece 1, preferably the outer sleeve 2, the hollow head sleeve 2′, or the interior 11 of the handpiece 1 and in particular to prevent excessive heating in the handpiece 1 or in a head part 16 of the handpiece 1, a temperature measurement device 4 is provided.

Via an electrical line or signal line 22, the temperature measurement device 4 is connected to control and evaluation unit 23 for evaluating the measured signals of the temperature measurement device 4 and/or as a control and evaluation unit 23 for temperature dependent control or operation of the handpiece 1 for example interrupting the operation of the handpiece 1 upon reaching or exceeding a predetermined temperature limit value and/or as a display unit for displaying the measured or determined temperature value or temperature limit value. Preferably, at least parts of control and evaluation unit 23 are provided on or in the handpiece 1. According to a particularly preferred embodiment, the entire temperature measurement device including the line 22 and control and evaluation unit 23 are arranged in or on the handpiece 1 whereby in particular with respect to the temperature measurement, evaluation, and the independent control or regulation independent handpiece 1 is formed.

The handpieces 1 of FIGS. 1 and 2 each have a temperature measurement device 4 which is designed to measure the temperature of the handpiece 1 or part of the handpiece 1 or heat emitted by the heat sources 5, 6, 7, interior 11 in a contact-less manner by detection of electromagnetic radiation, in particular heat radiation.

The temperature measurement device 4 of FIG. 2 has, a pyrometer or an infrared sensor 9 which are designed to electromagnetic radiation in a range of about 5 microns to 20 microns. The pyrometer or the infrared sensor 9 is preferably formed as a semiconductor sensor. Preferably, the pyrometer or the infrared sensor 9 further includes a device for self-temperature regulation such as a resistor. The handpiece 1 of FIG. 2 includes a first and a second thermocouple 8, 8′ where first thermocouple is provided on the outer sleeve 2 and the second thermocouple is provided on a component of the handpiece 1. In particular, the comprises material that is part of the thermocouple. Preferably the component is formed by the outer sleeve 2, the hollow head sleeve 2′ as in the above for the handpiece 1 is described. For each thermocouple of the handpiece 1, an electrical lead 22 leads to control and evaluation unit 23 which receives and processes the thermo-voltage signals of the first and second thermocouples.

If a handpiece 1 has a plurality of thermocouples or the thermocouple connections, its number as well as its position in the handpiece 1 or its construction as required or desired where the temperature is to be measured are of course freely selectable. Thus, for example, a plurality of free thermocouples in contact-less manner with a component or components of the handpiece 1 and/or several thermocouples arranged on one component and/or on a plurality of different components of the handpiece maybe provided on the handpiece.

Furthermore, all features of all described and illustrated embodiments can be combined. For example, it is also possible to provide different sensors in a handpiece 1, for example an infrared sensor 9 and a thermocouple. The measurement signals emitted by the different sensors can either be evaluated separately and/or combined for a common evaluation, for example to form a temperature average or a weighted temperature value, preferably by control and evaluation unit 23.

The invention is not limited to the described embodiments but includes all embodiments that apply or include the principle, analogous principle of operation of the handpiece 1. Thus, the position of the temperature measurement device 4 in the handpiece 1 is variable and not limited exclusively to the head part 16 of the handpiece 1. In general, the temperature measurement device 4 can be arranged at arbitrary locations in the handpiece 1, in where heat sources are positioned in the handpiece 1 or where an outer surface of the hand 1 becomes particularly warm.

### Control and Evaluation Unit

Control and evaluation unit 23 is used to obtain one or more temperature measurements obtained from the infrared sensor 9 and a thermocouple. The temperature measurements obtained from the infrared sensor 9 and a thermocouple are taken from the handpiece 1, thereby aiding in helping avoid bone and pulp necrosis and reducing patient discomfort. Additionally, temperature measurements may be taken from the patient's body, such as, by way of non-limiting example, oral cavity tissue, thereby further aiding in helping avoid bone and pulp necrosis and reducing patient discomfort. The oral cavity tissue can be tissue, such as tissue expected to be affected by heat generated by the operation of the handpiece 1. By way of non-limiting example, the tissue can be bone mass or tooth structure, or other tissue that may be compromised by the operation of the handpiece 1

Additionally, control and evaluation unit 23 senses power applied to the power source and/or drive device of the tool, for example, an electric motor or pneumatically operated motor, is connectable. Optionally, further electrical lines or contacts for data and/or signal transmission to the coupling device 18 are provided to drive the tool or handpiece 1. The energy detected thereby can be equated to additional heat, which can be presumed to increase temperature measurements, while the temperature may be decreased by water flow.

The use of the infrared sensor 9 allows sensing of surfaces external to the tool or handpiece 1. This can be accomplished by sensing the patient's tissues. Alternatively, material or a standardized thermal target (not shown) external to the tool or handpiece 1 can be used for sensing by the pyrometer or the infrared sensor 9.

By using the data from the infrared sensor 9, the thermocouple and the power applied to the power source, control and evaluation unit 23 can be used to provide an indication of temperatures to which the patient is exposed. Power applied to the handpiece 1 is sensed by control and evaluation unit 23, so that control and evaluation unit 23 is able to evaluate torque applied to the handpiece 1 and torque resistance at the handpiece 1. Since this torque and torque resistance is translated to heat, control and evaluation unit 23 can use this data to provide a prediction of increase in temperature caused by power applied to the handpiece 1, and use this to limit power to an extent necessary to reduce exposure of the patient to elevated temperatures. This limiting can be automatic, or by providing an appropriate signal to the dentist or operator.

In the case of water being provided during the operation, control and evaluation unit 23 is able to use a determination of water flow or a determination that water flow is in operation to provide a reduced estimate of the temperatures to which the patient would be exposed as a result of control and evaluation unit 23 evaluating torque applied to the handpiece 1 and torque resistance at the handpiece 1, in which the handpiece 1 could be a heat source. In general, when water is used to provide motive power for the handpiece 1, the temperature sensed by the pyrometer or the infrared sensor 9 will be correspondingly reduced; however, since energy is applied to the patient's tissue via handpiece 1, the power would still be part of the evaluation performed by control and evaluation unit 23 with adjustments made according to temperature sensed by the pyrometer or the infrared sensor 9.

When the indication of temperatures to which the patient is exposed exceeds a desired threshold, a signal may be provided to the operator and/or the power applied to the handpiece 1 can be attenuated. This allows the dentist or other operator to use the tool without arbitrarily determining whether the patient is being exposed to too much heat. Instead, control and evaluation unit 23 can provide the appropriate temperature indications or automatically control power applied to the handpiece 1 so as to limit exposing the patient to undesirable high temperatures.

### CLOSING STATEMENT

It is to be understood that the handpiece is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

What is claimed is:

1. A dental handpiece for providing oral treatment, comprising:
a shaft;
a hollow outer sleeve with an interior space;
a drive device for moving a connectable handpiece tool;
bearings for said handpiece tool;
a head part of said handpiece including an opening for inserting said connectable handpiece tool;
a hollow head sleeve;
a tool holder and actuator for actuating a tool release device for releasing said connectable handpiece tool;
at least one temperature measurement device to measure a temperature of oral cavity tissue in a contact-less manner by measuring the electromagnetic radiation emitted from the oral cavity tissue;
at least one additional temperature measurement device to measure a temperature of at least one heat source associated with the handpiece;
a control and evaluation unit receiving temperature measurement signals from the temperature measurement device measuring oral cavity tissue and from the additional temperature measurement device measuring temperature of said at least one heat source, the control and evaluation unit evaluating the temperature measurement signals and providing a temperature dependent control signal to interrupt or otherwise control the operation of said handpiece upon reaching or exceeding a predetermined temperature limit value;
a power source for supplying electrical power to said handpiece; and
the control and evaluation unit generating control signals responsive to the evaluated temperature measurement signals and regulating operation of said handpiece in response to the evaluated temperature measurement signals.

2. The dental handpiece of claim 1, further comprising:
the control and evaluation unit measuring further power applied to the handpiece and using the power applied to the handpiece in an evaluation of heat applied to the patient's tissue,
wherein said at least one temperature measurement device is configured to measure the temperature of said at least one heat source from heat generated by supplying said electrical power to said hand-piece and from heat generated by friction of the dental handpiece upon compromised bone mass or a tooth structure of a patient.

3. The dental handpiece of claim 1, further comprising:
the control and evaluation unit measuring further power applied to the handpiece and using the power applied to the handpiece in an evaluation of heat applied to the patient's tissue.

4. The dental handpiece of claim 1, further comprising a lighting device for providing light to a treatment area.

5. The dental handpiece of claim 1 wherein said at least one temperature measurement device is an active sensor.

6. The dental handpiece of claim 1 wherein said at least one temperature measurement device is a passive sensor.

7. The dental handpiece of claim 1 wherein said at least one temperature measurement device is a pyrometer or infrared sensor for detecting electromagnetic radiation in a range of five to twenty microns.

8. The dental handpiece of claim 1 wherein said at least one temperature measurement device is a thermocouple provided on a component of the handpiece.

9. The dental handpiece of claim 1 wherein said drive device is an electric motor or a pneumatically operated motor.

10. The dental handpiece of claim 1 wherein said tool holder is movable within the handpiece in a rotatable fashion as a result of roller or ball bearings.

11. The dental handpiece of claim 1 wherein said at least one temperature measurement device is an electrical temperature measurement device such as an ohmic resistor.

12. The dental handpiece of claim 11 wherein said at least one temperature measurement device is an electrical temperature measurement device such as an electrical conductor from the group of: a metal, a ceramic, a sintered metal oxide, or a doped semiconductor.

13. The dental handpiece of claim 1 wherein the at least one temperature measurement device provides an average temperature, an averaged temperature, or a weighted average temperature of the at least one heat source, a plurality of heat sources, at least one component, or a plurality of components.

14. The dental handpiece of claim 1 wherein the at least one temperature measurement device is connected to the control and evaluation unit, and providing a temperature limit value to a display associated with said handpiece.

15. A method for providing oral treatment with a dental handpiece, the method comprising:
providing a dental handpiece comprising a shaft, a hollow outer sleeve with an interior space, a drive device for moving a connectable handpiece tool, bearings for said handpiece tool, a head part of said handpiece including an opening for inserting said connectable handpiece tool, a hollow head sleeve, and a tool holder and actuator for actuating a tool release device for releasing said connectable handpiece tool;
providing at least one temperature measurement device to measure a temperature of oral cavity tissue in a contact-less manner by measuring the electromagnetic radiation emitted from the oral cavity tissue;
providing at least one additional temperature measurement device to measure a temperature of at least one heat source associated with the handpiece;
using a control and evaluation unit receiving temperature measurement signals from the temperature measurement device to measure temperatures of oral cavity tissue and to measure temperature of said at least one heat source, the control and using the evaluation unit to evaluate the temperature measurement signals and providing a temperature dependent control signal to interrupt or otherwise control the operation of said handpiece upon reaching or exceeding a predetermined temperature limit value; and
using the control and evaluation unit generating control signals responsive to the evaluated temperature measurement signals and regulating a power source for supplying electrical power to said handpiece to control operation of said handpiece in response to the evaluated temperature measurement signals.

16. The method of claim 15, further comprising:
using the dental handpiece for removing bones and tooth structures during oral surgical procedures,
wherein said at least one temperature measurement device is configured to measure the temperature of at said at least one heat source from heat generated by supplying said electrical power to said hand-piece and from heat generated by friction of the dental handpiece upon compromised bone mass or a tooth structure of a patient.

17. A method for providing oral treatment with a dental handpiece, the method comprising:
dental handpiece means comprising a mechanism for releasably supporting a connectable handpiece tool rotable with respect to a handle, and having a tool release device for releasing said connectable handpiece tool;
temperature measurement means capable of measuring a temperature of oral cavity tissue in a contact-less manner;
at least one additional temperature measurement device to measure a temperature of at least one heat source of said handpiece;
a control and evaluation unit receiving temperature measurement signals from the temperature measurement device to measure temperatures of oral cavity tissue and to measure temperature of said at least one heat source, the control and the evaluation unit evaluating the temperature measurement signals and providing a temperature dependent control signal to interrupt or control the operation of said handpiece upon reaching or exceeding a predetermined temperature limit value; and
regulation means responsive to the control and evaluation unit to generate control signals responsive to the evaluated temperature measurement signals and to regulate a power source for supplying electrical power to said handpiece to control operation of said handpiece in response to the evaluated temperature measurement signals.

19. The dental handpiece of claim 17, further comprising:
the control and evaluation unit measuring further power applied to the handpiece and using the power applied to the handpiece in an evaluation of heat applied to the patient's tissue,
wherein said at least one temperature measurement device is configured to measure the temperature of said at least one heat source from heat generated by supplying said electrical power to said hand-piece and from heat generated by friction of the dental handpiece upon compromised bone mass or a tooth structure of a patient.
